(19) United States
(12) Patent Application Publication
(10) Pub. No.: US 2026/0135421 A1
(43) Pub. Date: May 14, 2026

(54) STATOR FOR ELECTRIC MOTOR

(71) Applicant: NOVARES FRANCE, Vélizy-Villacoublay (FR)

(72) Inventors: Thomas JEAN, HAILLICOURT (FR); Eric KMIEC, FRESNICOURT LE DOLMEN (FR); Cédric LEDIEU, MONT SAINT ELOI (FR)

(21) Appl. No.: 19/119,309

(22) PCT Filed: Oct. 11, 2023
(86) PCT No.: PCT/FR2023/051585

§ 371 Date: Apr. 8, 2025

(30) Foreign Application Priority Data
Oct. 14, 2022 (FR) FR2210576

(51) Int. Cl. H02K 1/16; H02K 5/24

(52) U.S. Cl. CPC H02K 1/165; H02K 5/24; H02K 2213/03

(57) ABSTRACT

The present disclosure relates to a stator for an electric motor, comprising: a stator body forming a ring extending along an axis between a front end face and a rear end face the stator body including an outer peripheral face and an inner peripheral face provided with teeth the teeth defining, in pairs, a plurality of notches open towards the inside of the stator body; a plurality of conductor segments inserted at least partially into the notches of the stator body; wherein the stator body is provided with at least one internal cavity, the at least one internal cavity housing at least one sound-absorbing or structural damping element, the at least one sound-absorbing or structural damping element being able to attenuate the vibrations and/or mechanical and/or magnetic noises generated by the stator during its operation within the electric motor.

### CROSS REFERENCE TO RELATED APPLICATIONS

This application is a National Stage of PCT Application No. PCT/FR 2023/051585 filed on Oct. 11, 2023, which claims priority to French Patent Application No. 22/10576 filed on Oct. 14, 2022, the contents each of which are incorporated herein by reference thereto.

### TECHNICAL FIELD

The present disclosure concerns a stator for an electric motor. The present disclosure also concerns an electric motor comprising such a stator.

### BACKGROUND

Generally, current electric motors include a rotor secured to a shaft and a stator which surrounds the rotor. The stator is mounted in a casing which includes bearings for the rotational mounting of the shaft. The rotor includes a body formed by a lamination bundle or polar wheels (claw pole) held in the form of a stack by means of a suitable fastening system. The body of the rotor includes inner cavities housing permanent magnets. The stator includes a body consisting of a lamination bundle forming a crown, the inner face of which is provided with teeth delimiting two by two a plurality of slots open towards the inside of the stator body and intended to receive phase windings. These phase windings pass through the slots of the stator body and form winding heads protruding on either side from the stator body. The phase windings may for example consist of a plurality of U-shaped conductor segments, the free ends of two adjacent segments being connected together by welding.

During their operation, electric motors often generate noises that can be annoying for people nearby. These noises can be mechanical and result from impacts or friction between the mechanical parts during the rotation of the rotor. They can also be magnetic and be generated by the magnetic forces produced by the currents flowing in the electric motor. Indeed, these magnetic forces can cause the structure of the electric motor to vibrate at audible frequencies (from 20 Hz to 20 kHz), and these vibrations are transmitted to the ambient air by the structure, generating noise.

In particular, the stator may be subjected under the effect of electromagnetic forces to micro-displacements at high frequency and in the audible range of the human ear. These vibrations are then transmitted to the rest of the structure of the electric motor.

To reduce the noise pollution generated by electric motors, one of the solutions currently being considered consists of partially or completely encapsulating the stator. Nonetheless, this solution has the disadvantage of increasing the volume and mass of the electric motor. Another possible solution consists of reinforcing the acoustic insulation between the motor compartment and the habitable interior of the vehicle. Nonetheless, this solution has the disadvantage of not reducing the noise diffused outside the vehicle.

### BRIEF SUMMARY

One of the aims of the present disclosure is therefore to propose a solution to the problem of noise pollution generated by the electric motors as described above, and, in particular, to propose a solution making it possible to reduce the noise generated by the stator.

For this purpose, the present disclosure concerns a stator for an electric motor comprising:
a stator body forming a crown extending along an axis between a front end face and a rear end face, the stator body including an outer peripheral face and an inner peripheral face provided with teeth, the teeth delimiting two by two a plurality of slots open towards the inside of the stator body;
a plurality of conductor segments inserted at least partially into the slots of the stator body;

characterized in that the stator body is provided with at least one inner cavity, the at least one inner cavity housing at least one sound-absorbing or structural damping element, the at least one sound-absorbing or structural damping element being capable of attenuating the vibrations and/or mechanical and/or magnetic noises generated by the stator during its operation within the electric motor.

Thus configured, the stator of the present disclosure makes it possible to reduce the noise generated during its operation due to the presence of an element capable of absorbing the mechanical and/or magnetic noise and/or damping vibrations inside an inner cavity of the stator body.

The stator of the present disclosure may also comprise one or more of the following features:
the at least one inner cavity comprises a main segment forming a ring about the axis of the stator body, a first plurality of so-called front secondary segments extending from the main segment towards the front end face of the stator body and a second plurality of so-called rear secondary segments extending from the main segment towards the rear end face of the stator body.
each front and rear secondary segment is rectilinear and is oriented obliquely relative to the main segment.
each front and rear secondary segment is rectilinear and is oriented perpendicular to the main segment.
the front and rear secondary segments form tubular holes having a parallelepiped base.
each secondary segment being defined by a width B, measured in an orthoradial direction, and a length D, measured in a radial direction. The width B is proportional to the width A of a section formed by a tooth and a slot, as measured in an orthoradial direction, the ratio between the width B and the width A being preferably comprised between 0.25 and 0.75, and the length D is proportional to the distance C separating an inner end edge of a slot from the outer peripheral face of the stator body, as measured in a radial direction, the ratio between the length D and the distance C being preferably comprised between 0.25 and 0.75.
the stator body comprises at least one radial opening emerging, on one side, on the central segment of the at least one inner cavity and, on the other side, at the outer peripheral face of the stator body, the at least one radial opening allowing the injection of a filling material inside the at least one inner cavity.
the stator comprises a plurality of through orifices emerging, on one side, on one of the front, respectively rear, secondary segments, and, on the other side, at the front, respectively rear end face, the through orifices being configured to allow air to pass through but not the filling material.
the through orifices are cylindrical in shape and have a diameter comprised between 0.02 mm and 0.2 mm.
the at least one sound-absorbing or structural damping element has a shape complementary to that of the at least one inner cavity.
the at least one sound-absorbing or structural damping element is made of a material selected from a silicone material, a thermoplastic elastomer, and a heavy mass.

The present disclosure also concerns an electric motor comprising a stator as defined above.

### BRIEF DESCRIPTION OF THE DRAWINGS

The present disclosure will be better understood upon reading the non-limiting description which follows, given with reference to the appended figures.

FIG. 1 is a perspective view of an electric motor incorporating a stator according to the present disclosure.

FIG. 2 is a cross-sectional view of the motor shown in FIG. 1.

FIG. 3 is a perspective view of the stator equipping the motor of FIG. 1.

FIG. 4 is a front axial view of the stator of FIG. 3.

FIG. 5 is a cross-sectional view of the body of the stator of FIG. 3 along the section plane P.

FIG. 6 is a perspective view of the body of the stator of FIG. 3 according to a first embodiment, an outer peripheral layer of the body having been removed so as to reveal the inner cavity.

FIG. 7 is a top view of the stator shown in FIG. 6.

FIG. 8 is a perspective view of the body of the stator of FIG. 3 according to a second embodiment, an outer peripheral layer of the body having been removed so as to reveal the inner cavity.

FIG. 9 is a top view of the stator shown in FIG. 8.

FIG. 10 is a front axial view of a structural detail of the stator body of FIG. 3.

### DETAILED DESCRIPTION

Throughout the description and claims, the terms «axial» and «radial» and their derivatives are defined with respect to the longitudinal axis along which the stator extends and which passes through the center of the stator. Thus, an axial orientation refers to an orientation parallel to the longitudinal axis of the stator and a radial orientation refers to an orientation perpendicular to the longitudinal axis of the stator. Furthermore, by convention, the terms «front» and «rear» refer to separate positions along the longitudinal axis of the stator. In particular, the term «front» corresponds to the parts of the stator that adjoin the end of the rotor shaft on which a pulley, a pinion, a groove intended to transmit the rotational movement of the rotor to any other similar movement transmission device can be fixed. The term «rear» therefore corresponds to the parts of the stator that adjoin the other end of the rotor shaft.

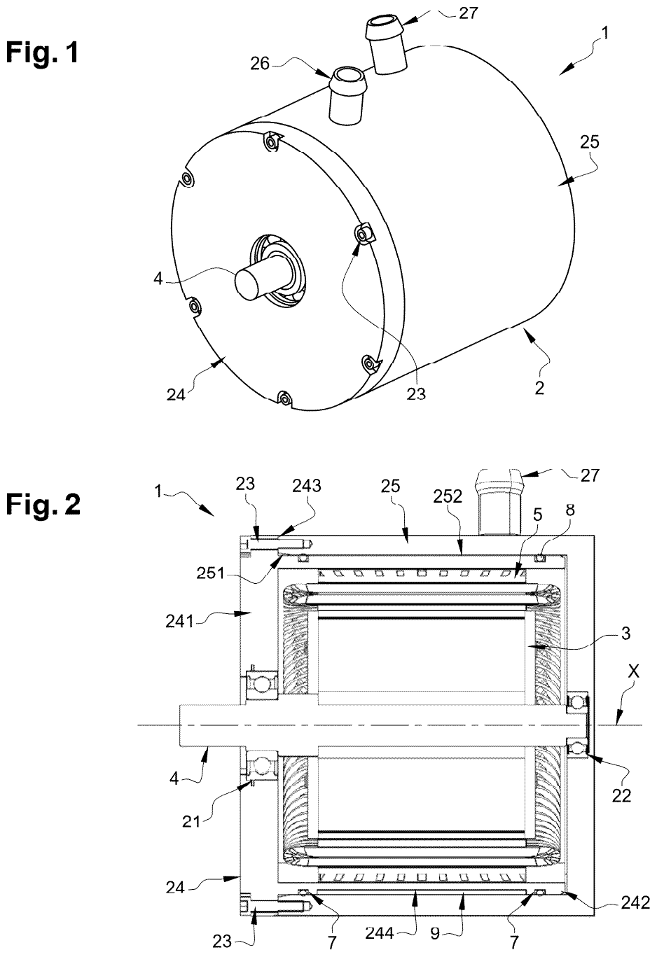

Referring to FIG. 1, an electric motor 1 implementing a stator in accordance with the present disclosure is shown. This electric motor 1 comprises in particular a casing 2 in two parts housing the rotor 3 secured in rotation to a shaft 4 mounted rotatably about an axis X and an annular stator 5 which surrounds the rotor 3 coaxially with the shaft 4. The casing 2 consists in particular of a front bearing 24 and a rear bearing 25 connected to each other by means of fixing screws 23. The bearings 24, 25 are hollow in shape and each centrally carry a ball bearing respectively 21 and 22 for the rotational mounting of the shaft 4.

The rear bearing 25 consists of a bell-shaped cover which, in the mounted position of the motor shown in FIG. 2, completely covers a cylindrical part 242 of the front bearing 24 which extends axially from an end face 241 of the front bearing 24, the face 241 having the shape of a disk aligned in a plane perpendicular to the axis X of the shaft 4. The rear bearing 25 rests at an end edge 251 on a shoulder 243 defined by the end face 241.

The rear bearing 25 has a shape substantially complementary to that of the cylindrical part 242 of the front bearing 24 so that, in the mounted position of the motor, this part 242 is in sealed contact with the inner wall 252 of the rear bearing 25, the sealing being ensured by two annular-shaped seals 8 which are housed inside two annular grooves 7 formed on the periphery of the part 242. The grooves 7 are arranged on either side of a zone 244 of lower thickness of the part 242. The zone 244 forms with the inner wall 252 of the rear bearing 25 an inner channel 9 for circulation of liquid. The channel 9 thus allows the circulation of a cooling liquid, such as for example water, glycol or an oil, around the cylindrical part 242 of the front bearing 24. Thus, during operation of the motor 1, the heat released by the stator 5 and transmitted to the front bearing 24 can be directly transferred to the cooling liquid circulating in the inner channel 9. A faster cooling of the stator 5 can thus be obtained. The heat transfer to the cooling liquid is further improved in the case where the front bearing 24 is made of a material having a high thermal conductivity, such as aluminum for example, and the rear bearing 25 is made of a material with a low thermal conductivity, such as a plastic material for example. The cooling liquid supply will be through a liquid inlet pipe 26 formed at the periphery of the rear bearing 25, the inlet pipe 26 opening into the inner channel 9. The cooling liquid outlet will be through a liquid outlet pipe 27 formed at the periphery of the rear bearing 25, the outlet pipe 27 also emerging into the inner channel 9.

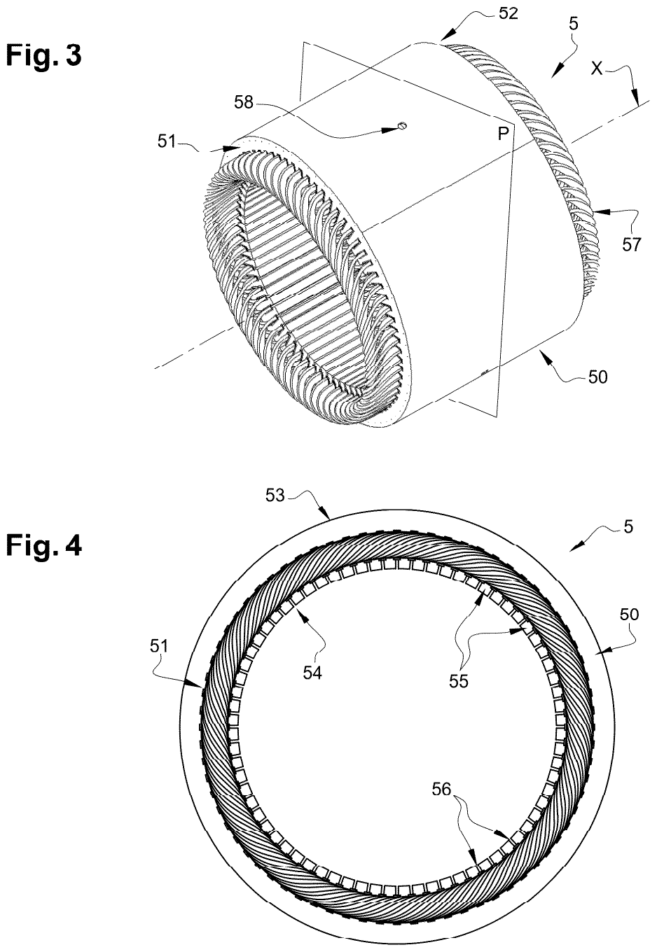

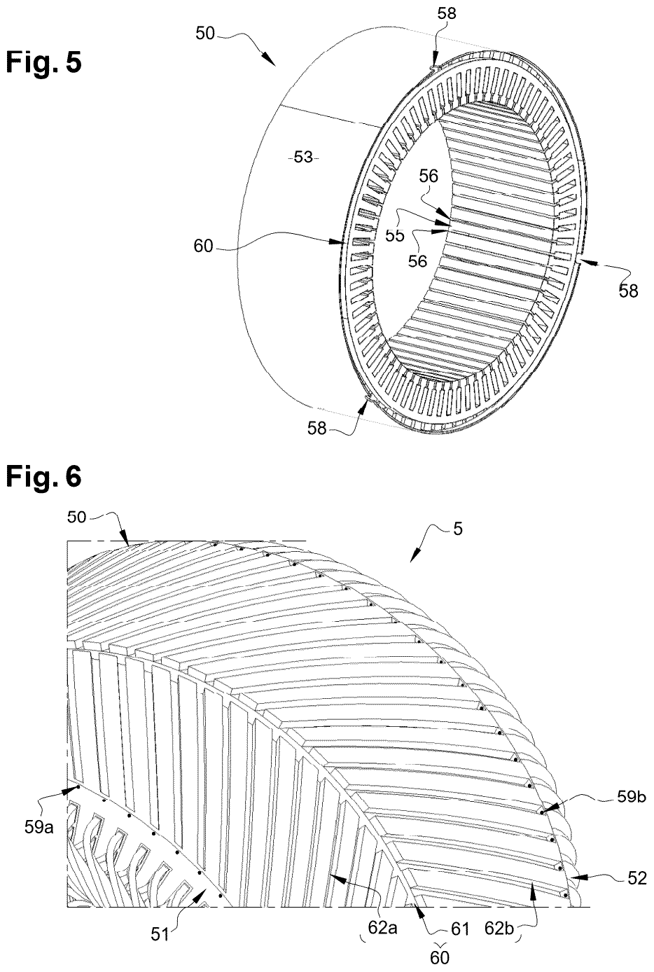

Referring to FIGS. 3 and 4, the stator 5 equipping the motor of FIGS. 1 and 2 is shown. This stator 5 comprises a body 50 in the form of a crown extending along the axis X between a front end face 51 and a rear end face 52. The body 50 is constituted by a pile of laminations held in the form of a stack by means of a suitable fixing system. The body 50 includes a substantially cylindrical outer peripheral face 53 and an inner peripheral face 54 provided with teeth 55 extending parallel to the axial direction X and regularly spaced around the circumference of the body 50. The teeth 55 delimit two by two a plurality of slots 56 intended to at least partially accommodate a plurality of U-shaped conductor segments 57. Thus, two successive slots 56 are separated by a tooth 55 as shown in FIG. 5. The slots 56 open axially onto the front and rear end faces 51, 52 of the stator body 50 and radially onto the inner peripheral face 54 of the body 50.

As shown in FIG. 5, the body 50 is also provided with several radial openings 58 on its outer peripheral face 53. These radial openings 58 open into an inner cavity 60 formed inside the stator body 50. These radial openings 58 will thus make it possible to inject a filling material (not shown) inside the inner cavity 60. The filling material will in particular have specific characteristics making it particularly suitable for attenuating the vibrations and/or mechanical and/or magnetic noises generated by the stator during its operation within the electric motor.

It may thus advantageously be selected from a silicone material, a thermoplastic elastomer (for example of the Hytrel® type or of the PP/EPDM type), and a heavy mass.

Once the injection operation is complete, this filling material will form a sound-absorbing or structural damping element that will completely fill the inner cavity 60. This sound-absorbing or structural damping element will therefore have a shape complementary to that of the inner cavity 60. The sound-attenuation effect obtained by means of this sound-absorbing or structural damping element will therefore depend on the shape of the inner cavity 60.

Two preferred shapes of inner cavity have been shown respectively in FIGS. 6-7 and 8-9. These preferred shapes are obviously not limiting for the present disclosure. Any other shape of inner cavity making it possible to effectively reduce the noise generated by the stator may be envisaged at this level. In particular, it may be possible to provide the stator with several inner cavities separated from each other, each inner cavity housing a specific sound-absorbing or structural damping element.

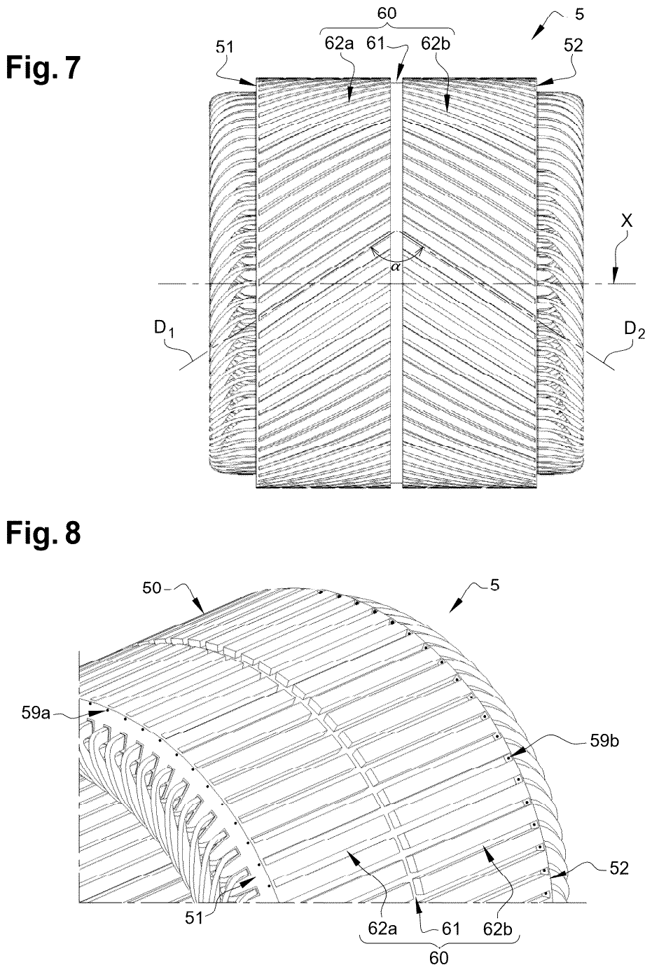

With reference to FIGS. 6 and 7, a first embodiment of a stator body according to the present disclosure is shown. In this embodiment, the inner cavity 60 comprises a main segment 61, forming a ring about the axis X of the stator body 50, and several secondary segments 62a, 62b extending from the main segment 61 towards the end faces 51, 52 of the stator body 50, respectively secondary segments 62a, called front, extending from the main segment 61 towards the front end face 51 and secondary segments 62b, called rear, extending from the main segment 61 towards the rear end face 52. Each front and rear secondary segment 62a, 62b is rectilinear and is oriented obliquely relative to the main segment 61. In the configuration shown in FIG. 7, the front secondary segments 62a are parallel to the same direction D1 and the rear secondary segments 62b are parallel to the same direction D2, the direction D1 forming an angle a with the direction D2. This angle a will preferably be comprised between 30° and 120°.

In the configuration shown in FIG. 6, the front and rear secondary segments 62a, 62b have a tubular shape with a parallelepiped base. As illustrated in FIG. 10, these secondary segments 62a, 62b will be defined by a width B, measured in an orthoradial direction, and a length D, measured in a radial direction. The width B may be proportional to the width A of a section formed by a tooth 55 and a slot 56, as measured in an orthoradial direction. In particular, the ratio between the width B and the width A may be comprised between 0.25 and 0.75. Similarly, the length D may be proportional to the distance C separating the inner end edge of a slot 56 from the outer peripheral wall 53 of the stator body 50, as measured in a radial direction. In particular, the ratio between the length D and the distance C may be comprised between 0.25 and 0.75.

According to other configurations of the present disclosure (not shown), the secondary segments may also have a tubular shape with a circular base.

As shown in FIG. 6, the stator body 50 is also provided with a plurality of first and second through orifices 59a and 59b. Each of the first through orifices 59a opens, on one side, onto one of the front secondary segments 62a and, on the other side, at the front end face 51 and each of the second through orifices 59b opens, on one side, onto one of the rear secondary segments 62b and, on the other side, at the rear end face 52. The first and second through orifices 59a, 59b will serve as vents during the operation of injecting the filling material inside the inner cavity 60, thus preventing the formation of an air pocket inside the stator body. The through orifices 59a, 59b must thus be wide enough to allow air to pass through but narrow enough to prevent the passage of the filling material.

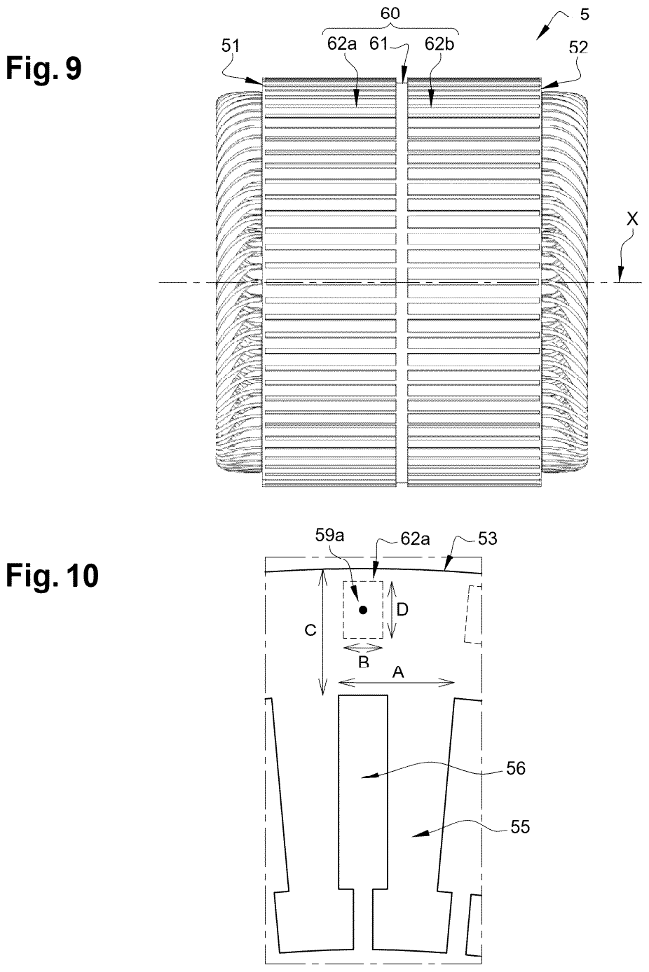

With reference to FIGS. 8 and 9, a second embodiment of a stator body according to the present disclosure is shown. This embodiment differs from that of FIGS. 6 and 7 in that each front and rear secondary segment 62a, 62b is oriented perpendicular to the main segment 61.

In the configuration shown in FIG. 8, the front and rear secondary segments 62a, 62b have a tubular shape with a parallelepiped base. As illustrated in FIG. 10, these secondary segments 62a, 62b will be defined by a width B, measured in an orthoradial direction, and a length D, measured in a radial direction. The width B may be proportional to the width A of a section formed by a tooth 55 and a slot 56, as measured in an orthoradial direction. In particular, the ratio between the width B and the width A may be comprised between 0.25 and 0.75. Similarly, the length D may be proportional to the distance C separating the inner end edge of a slot 56 from the outer peripheral wall 53 of the stator body 50, as measured in a radial direction. In particular, the ratio between the length D and the distance C may be comprised between 0.25 and 0.75.

According to other configurations of the present disclosure (not shown), the secondary segments may also have a tubular shape with a circular base.

As shown in FIG. 8, the stator body 50 is also provided with a plurality of first and second through orifices 59a and 59b. Each of the first through orifices 59a opens, on one side, onto one of the front secondary segments 62a and, on the other side, at the front end face 51 and each of the second through orifices 59b opens, on one side, onto one of the rear secondary segments 62b and, on the other side, at the rear end face 52. The first and second through orifices 59a, 59b will serve as degassing vents during the operation of injecting the filling material inside the inner cavity 60, thus preventing the formation of an air pocket inside the stator body. The through orifices 59a, 59b must thus be wide enough to allow air to pass through but narrow enough to prevent the passage of the filling material. In particular, the through holes 59a, 59b may be cylindrical in shape and have a diameter comprised between 0.02 mm and 0.2 mm.

1. A stator for an electric motor, comprising:
a stator body forming a crown extending along an axis between a front end face and a rear end face, the stator body including an outer peripheral face and an inner peripheral face provided with teeth, the teeth delimiting two by two a plurality of slots open towards the an inside of the stator body
a plurality of conductor segments inserted at least partially into the plurality of slots of the stator body;
wherein the stator body is provided with at least one inner cavity, the at least one inner cavity housing at least one sound-absorbing or structural damping element, the at least one sound-absorbing or structural damping element being capable of attenuating vibrations and/or mechanical and/or magnetic noises generated by the stator during its operation of the stator within the electric motor.

2. The stator according to claim 1, wherein the at least one inner cavity comprises a main segment forming a ring about the axis of the stator body, a first plurality of so-called front secondary segments extending from the main segment towards the front end face of the stator body and a second plurality of rear secondary segments extending from the main segment towards the rear end face of the stator body.

3. The stator according to claim 2, wherein each one of the front secondary segments and each one of the rear secondary segments is rectilinear and is oriented obliquely relative to the main segment.

4. The stator according to claim 2, wherein each one of the front secondary segments and each one of the rear secondary segments is rectilinear and is oriented perpendicular to the main segment.

5. The stator according to claim 2, wherein the front secondary segments and the rear secondary segments form tubular holes having a parallelepiped base.

6. The stator according to claim 5, wherein each one of the front secondary segments and each one of the rear secondary segments is defined by a width B, measured in an orthoradial direction, and a length D, measured in a radial direction, the width B is proportional to a width A of a section formed by a tooth and a slot, as measured in an orthoradial direction, a ratio between the width B and the width A being between 0.25 and 0.75, and the length D is proportional to a distance C separating an inner end edge of a slot from the outer peripheral face of the stator body, as measured in a radial direction, a ratio between the length D and the distance C being between 0.25 and 0.75.

7. The stator according to claim 2, wherein the stator body comprises at least one radial opening emerging, on one side, onto the main segment of the at least one inner cavity and, on another side, at a level of the outer peripheral face of the stator body, the at least one radial opening allowing injection of a filling material inside the at least one inner cavity.

8. The stator according to claim 7, comprising a plurality of through orifices emerging, on one side, onto one of the front secondary segments and a respective one of the rear secondary segments, and, on another side, at the a level of the front end face, and the rear end face, said the plurality of through orifices being configured to allow air to pass through but not the filling material.

9. The stator according to claim 8, wherein the plurality of through orifices are cylindrical in shape and have a diameter between 0.02 mm and 0.2 mm.

10. The stator according to claim 1, wherein the at least one sound-absorbing or structural damping element has a shape complementary to that of the at least one inner cavity.

11. The stator according to claim 1, wherein the at least one sound-absorbing or structural damping element is made of a material selected from anyone of the following: a silicone material, a thermoplastic elastomer, and a heavy mass.

12. An electric motor comprising a stator according to claim 1.

13. The stator according to claim 3, wherein the front secondary segments and the rear secondary segments form tubular holes having a parallelepiped base.

14. The stator according to claim 13, wherein each one of the front secondary segments and each one of the rear secondary segments is defined by a width B, measured in an orthoradial direction, and a length D, measured in a radial direction, the width B is proportional to a width A of a section formed by a tooth and a slot, as measured in an orthoradial direction, a ratio between the width B and the width A being between 0.25 and 0.75, and the length D is proportional to a distance C separating an inner end edge of a slot from the outer peripheral face of the stator body, as measured in a radial direction, a ratio between the length D and the distance C being between 0.25 and 0.75.

15. The stator according to claim 4, wherein the front secondary segments and the rear secondary segments form tubular holes having a parallelepiped base.

16. The stator according to claim 15, wherein each one of the front secondary segments and each one of the rear secondary segments is defined by a width B, measured in an orthoradial direction, and a length D, measured in a radial direction, the width B is proportional to a width A of a section formed by a tooth and a slot, as measured in an orthoradial direction, a ratio between the width B and the width A being between 0.25 and 0.75, and the length D is proportional to a distance C separating an inner end edge of a slot from the outer peripheral face of the stator body, as measured in a radial direction, a ratio between the length D and the distance C being between 0.25 and 0.75.

17. The stator according to claim 3, wherein the stator body comprises at least one radial opening emerging, on one side, onto the main segment of the at least one inner cavity and, on another side, at a level of the outer peripheral face of the stator body, the at least one radial opening allowing injection of a filling material inside the at least one inner cavity.

18. The stator according to claim 17, comprising a plurality of through orifices emerging, on one side, onto one of the front secondary segments and a respective one of the rear secondary segments, and, on another side, at a level of the front end face, and the rear end face, said the plurality of through orifices being configured to allow air to pass through but not the filling material.

19. The stator according to claim 18, wherein the at least one sound-absorbing or structural damping element has a shape complementary to that of the at least one inner cavity.

20. The stator according to claim 19, wherein the at least one sound-absorbing or structural damping element is made of a material selected from anyone of the following: a silicone material, a thermoplastic elastomer, and a heavy mass.
